(19) United States
(12) Patent Application Publication
(10) Pub. No.: US 2007/0147831 A1
(43) Pub. Date: Jun. 28, 2007

(54) SUBSTRATE PROCESSING APPARATUS FOR PERFORMING EXPOSURE PROCESS

(76) Inventors: Koji Kaneyama, Kyoto (JP); Kazuhito Shigemori, Kyoto (JP); Masashi Kanaoka, Kyoto (JP); Tadashi Miyagi, Kyoto (JP); Shuichi Yasuda, Kyoto (JP)

Correspondence Address: OSTROLENK FABER GERB & SOFFEN, 1180 AVENUE OF THE AMERICAS, NEW YORK, NY, 100368403, US

(21) Appl. No.: 11/615,404

(22) Filed: Dec. 22, 2006

(30) Foreign Application Priority Data
Dec. 26, 2005 (JP) 2005-372682

(51) Int. Cl. G03D 5/00

(52) U.S. Cl. 396/611

(57) ABSTRACT

A substrate processing apparatus for performing an exposure process by printing a pattern on a substrate coated with a photosensitive material includes an exposure part for performing an immersion exposure process, a cleaning part and a transport mechanism which are provided within an exposure chamber. After the exposure part performs the immersion exposure process on the substrate, the substrate is transported to the cleaning part and is cleaned therein. If the liquid used during the immersion exposure process remains on the substrate after the exposure process, the substrate is cleaned in the cleaning part immediately after the exposure process. This prevents the remaining liquid from adhering to and contaminating mechanisms within the substrate processing apparatus. Also, the cleaning part is able to clean a dummy substrate for use in an alignment process in the exposure part.

### BACKGROUND OF THE INVENTION

1. Field of the Invention

The present invention relates to a substrate processing apparatus for performing an exposure process by printing a pattern on a substrate such as a semiconductor substrate, a glass substrate for a liquid crystal display device, a glass substrate for a photomask, a substrate for an optical disk and the like which are coated with a photosensitive material such as a photoresist.

2. Description of the Background Art

As is well known, semiconductor and liquid crystal display products and the like are fabricated by performing a series of processes including cleaning, resist coating, exposure, development, etching, interlayer insulation film formation, heat treatment, dicing and the like on the above-mentioned substrate. Of these various processes, the exposure process is the process of transferring a pattern of a reticle (a mask for printing) to a substrate coated with a photosensitive material such as a photoresist, and serves as a key part of what is called a photolithography process. Because the pattern is extremely fine, what is called step-and-repeat exposure, rather than single exposure of the entire wafer, is typically performed in such a manner that the wafer is exposed repeatedly in batches of several chips.

With the rapid increase in the density of semiconductor devices and the like in recent years, there has been a strong demand to make the mask pattern finer. Thus, light sources for an exposure apparatus for performing the exposure process which become dominant are deep-UV light sources such as a KrF excimer laser light source and an ArF excimer laser light source which emit light with relatively short wavelengths in place of conventional UV lamps. However, even the ArF excimer laser light source is insufficient to meet the requirement for much finer patterns of late. To solve such a problem, it is conceivable to use a light source which emits light with a shorter wavelength, e.g. an F2 laser light source, for the exposure apparatus. An immersion exposure processing method as disclosed in International Publication No. WO 99/49504 in the form of a pamphlet is presented as an exposure technique which is capable of providing the much finer patterns while reducing burdens in cost.

The immersion exposure processing method is the technique of performing “immersion exposure,” with the space between a projection optical system and a substrate filled with a liquid having a refractive index n (e.g., deionized water with n=1.44) greater than that of the atmosphere (n=1), to increase numerical aperture, thereby improving resolution. This immersion exposure processing method can provide an equivalent wavelength of 134 nm when a conventional ArF excimer laser light source (which emits light with a wavelength of 193 nm) is diverted directly, to achieve the finer pattern of the resist mask while suppressing growing burdens in cost.

It is important for such an immersion exposure processing method as well as for a conventional dry exposure process to precisely align a pattern image of the mask and an exposure area on the substrate with each other. Thus, an alignment process for calibrating the position of a substrate stage and a mask position to adjust the exposure position of the pattern image is performed also in an exposure apparatus compatible with the immersion exposure processing method. In the exposure apparatus compatible with the immersion exposure process, however, there is apprehension that liquid (liquid for immersion) enters the inside of the substrate stage during the alignment process to cause a trouble. To solve this problem, Japanese Patent Application Laid-Open No. 2005-268747 discloses a technique such that a dummy substrate is placed on the substrate stage for the execution of the alignment process. This prevents the liquid from entering the inside of the stage because the dummy substrate closes a recessed portion of the stage, as in the conventional exposure process.

In the immersion exposure processing method, however, the liquid for immersion comes in direct contact with the substrate to sometimes result in the liquid remaining on the substrate after the exposure process. Typically, the substrate subjected to the exposure process is transported from the exposure apparatus to a coater-and-developer, and is subjected to a development process in the coater-and-developer. If the liquid remains on the substrate, there is a likelihood that the liquid adheres to transport mechanisms and the like in the exposure apparatus and the coater-and-developer to contaminate the mechanisms.

In the alignment process disclosed in Japanese Patent Application Laid-Open No. 2005-268747, the liquid is prevented from entering the inside of the stage, but there is a likelihood that the liquid comes in contact with the dummy substrate itself to remain in the form of droplets on the substrate after the alignment process. Such droplets may adsorb extraneous matter such as particles to result in apprehension that only the extraneous matter adheres as contaminants to the dummy substrate after the liquid dries. The execution of the alignment process using the dummy substrate contaminated in this manner creates a problem such that the substrate stage and its surroundings are contaminated.

### SUMMARY OF THE INVENTION

The present invention is intended for a substrate processing apparatus for performing an exposure process by printing a pattern on a substrate coated with a photosensitive material.

According to the present invention, the substrate processing apparatus comprises: an exposure part for projecting a pattern image on a substrate; an exposure chamber for housing the exposure part; a cleaning part provided within the exposure chamber for performing a cleaning process on the substrate; and a transport element for transporting the substrate between the exposure part and the cleaning part.

The substrate processing apparatus is capable of performing the cleaning process on the substrate before and after the exposure to reduce contamination of mechanisms resulting from the exposure process.

Preferably, the substrate processing apparatus further comprises a housing part provided within the exposure chamber for housing a dummy substrate, the dummy substrate being used when the exposure part adjusts the exposure position of the pattern image, wherein the transport element transports the substrate or the dummy substrate between the exposure part, the cleaning part and the housing part, and wherein the cleaning part cleans the dummy substrate.

This maintains the dummy substrate clean to further reduce the contamination of the mechanisms resulting from the exposure process.

It is therefore an object of the present invention to provide a substrate processing apparatus capable of reducing contamination of mechanisms resulting from an exposure process.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic plan view showing the construction of a substrate processing apparatus according to the present invention;

FIG. 2 is a schematic view showing the construction of principal portions of an exposure part in the substrate processing apparatus of FIG. 1;

FIG. 3 is a schematic view showing the construction of principal portions of a cleaning part in the substrate processing apparatus of FIG. 1;

FIG. 4 is a view showing the construction of a cleaning unit shown in FIG. 3; and

FIG. 5 is a schematic sectional view showing an example of the structure of a two-fluid nozzle.

### DESCRIPTION OF THE PREFERRED EMBODIMENTS

A preferred embodiment according to the present invention will now be described in detail with reference to the drawings.

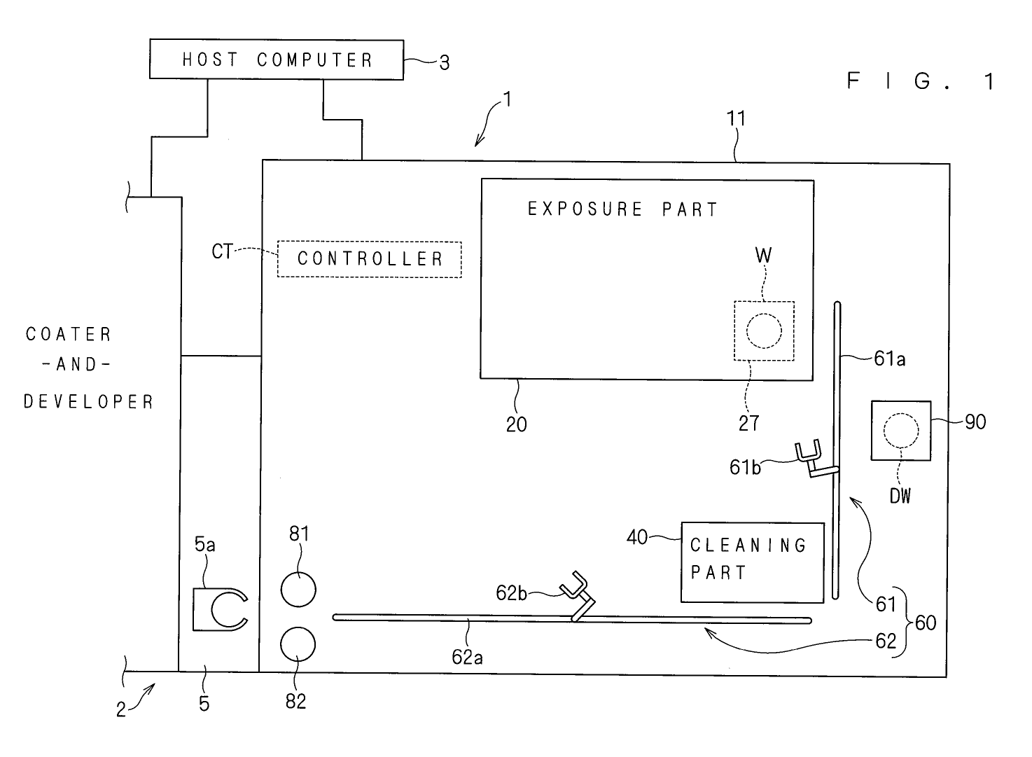

FIG. 1 is a schematic plan view showing the construction of a substrate processing apparatus according to the present invention. The substrate processing apparatus 1 according to the present invention is an exposure machine for performing an exposure process by printing a pattern of a mask on a substrate (e.g., a semiconductor wafer) coated with a photosensitive material such as a photoresist.

The substrate processing apparatus 1 is connected to a coater-and-developer 2. The coater-and-developer 2 is an apparatus for coating a substrate W with a photoresist, and for performing a development process on an exposed substrate W. The substrate processing apparatus 1 is disposed adjacent to an interface 5 of the coater-and-developer 2. The substrate W coated with the photoresist in the coater-and-developer 2 is transported into the substrate processing apparatus 1 by a transport robot 5a of the interface 5, and the substrate W subjected to the exposure process is transported by the transport robot 5a from the substrate processing apparatus 1 back into the coater-and-developer 2 and is subjected to the development process in the coater-and-developer 2. A host computer 3 is provided as a higher level computer for managing the substrate processing apparatus 1 and the coater-and-developer 2. The substrate processing apparatus 1, the coater-and-developer 2 and the host computer 3 are connected to each other via LAN lines for communication.

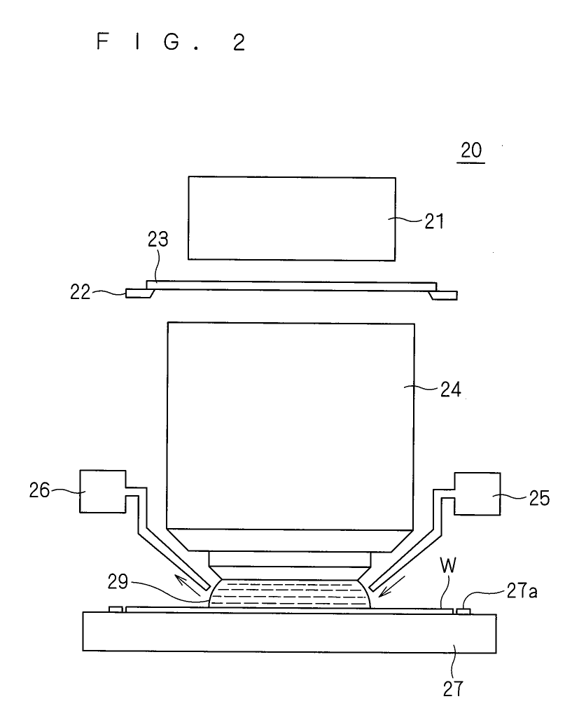

The substrate processing apparatus 1 principally includes an exposure chamber 11 serving as an enclosure, an exposure part 20 provided within the exposure chamber 11, a cleaning part 40 provided within the exposure chamber 11, and a transport mechanism 60 provided within the exposure chamber 11 for transporting a substrate W between the exposure part 20 and the cleaning part 40. The exposure part 20 is a processor for projecting a pattern image on a substrate W to perform the exposure process. FIG. 2 is a schematic view showing the construction of principal portions of the exposure part 20.

The exposure part 20 includes an illumination optical system 21, a mask stage 22, a projection optical system 24, a substrate stage 27, a liquid supply mechanism 25, and a liquid collecting mechanism 26. The illumination optical system 21 has a light source for emitting exposure light (e.g., ArF excimer laser light and KrF excimer laser light), a lens system for collecting the exposure light, and the like. The mask stage 22 holds a mask 23. The mask stage 22 is slidable in a horizontal plane and is slightly rotatable in a horizontal plane by a driving mechanism not shown. The mask 23 includes a reticle formed with a device pattern to be projected on a reduced scale onto the substrate W.

The projection optical system 24 is an optical system for projecting the pattern image of the mask 23 onto the substrate W at a predetermined magnification (in this preferred embodiment, a reducing system having a magnification less than unity) to expose the substrate W, and includes a plurality of lenses. The substrate stage 27 holds the substrate W thereon. The substrate stage 27 is slidable in a horizontal plane and vertically movable by a driving mechanism not shown. The angle of inclination of the substrate stage 27 is adjustable by the driving mechanism not shown. An auxiliary plate 27a is provided on the upper surface of the substrate stage 27 so that the substrate W is held in a recessed portion surrounded by the auxiliary plate 27a.

The liquid supply mechanism 25 supplies a predetermined liquid (in this preferred embodiment, deionized water) to a gap between the substrate W placed on the substrate stage 27 and the projection optical system 24. The liquid supply mechanism 25 includes a mechanism for feeding the liquid, and a supply nozzle for supplying the fed liquid onto the substrate W. The liquid collecting mechanism 26 collects the liquid filling the gap between the substrate W and the projection optical system 24. The liquid collecting mechanism 26 includes a collecting nozzle directed toward the gap between the substrate W and the projection optical system 24, and a mechanism for sucking the liquid through the collecting nozzle.

The exposure process is performed on a substrate W in the exposure part 20 in a manner to be described below. First, the substrate W is placed on the substrate stage 27, and the mask stage 22 supports the mask 23. Then, while the liquid supply mechanism 25 supplies the liquid onto the substrate W, the liquid collecting mechanism 26 collects the liquid. This forms a flow of liquid on the substrate W, and always fills the gap between the substrate W and the projection optical system 24 with the liquid with stability. In such conditions, exposure light is directed from the illumination optical system 21 onto the mask 23 so that the pattern image of the mask 23 is projected through the projection optical system 24 onto the substrate W to expose the substrate W. In this process, the gap between the projection optical system 24 and the substrate W is filled with the liquid having a high refractive index (in this instance, deionized water having a refractive index n=1.44). This substantially shortens the wavelength of the exposure light to improve resolution and to substantially widen the depth of focus. In other words, the exposure part 20 performs an “immersion exposure process” which projects a pattern image while supplying a liquid to the gap between the projection optical system 24 and the substrate W. Also, while moving the mask stage 22 and substrate stage 27 in opposite directions in synchronization with each other, the exposure part 20 exposes the substrate W repeatedly in batches of several chips into which the pattern formed on the mask 23 is divided (step-and-repeat exposure).

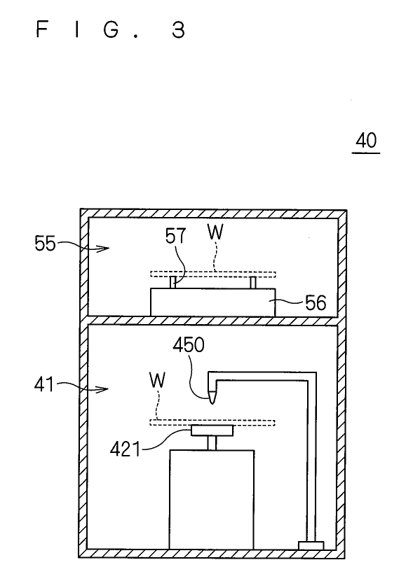

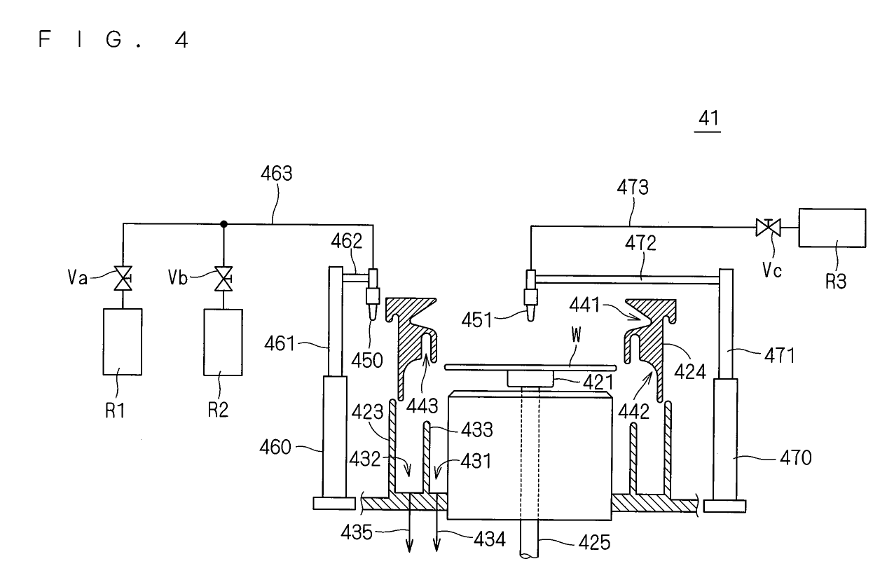

FIG. 3 is a schematic view showing the construction of principal portions of the cleaning part 40. The cleaning part 40 is provided within the exposure chamber 11 which houses the exposure part 20. As shown in FIG. 3, the cleaning part 40 according to this preferred embodiment includes a cleaning unit 41, and a stand-by unit 55 disposed on top of the cleaning unit 41 in stacked relation. FIG. 4 is a view showing the construction of the cleaning unit 41. The cleaning unit 41 includes a spin chuck 421 for rotating a substrate W about a vertical rotation axis passing through the center of the substrate W while holding the substrate W in a horizontal position.

The spin chuck 421 is fixed on the upper end of a rotary shaft 425 rotated by an electric motor not shown. The spin chuck 421 is formed with a suction passage (not shown). With the substrate W placed on the spin chuck 421, air is exhausted from the suction passage, whereby the lower surface of the substrate W is vacuum-held on the spin chuck 421, and the substrate W is held in a horizontal position.

A first pivoting motor 460 is provided on one side of the spin chuck 421. A first pivoting shaft 461 is connected to the first pivoting motor 460. A first arm 462 is coupled to the first pivoting shaft 461 so as to extend in a horizontal direction, and a cleaning nozzle 450 is provided on a distal end of the first arm 462. The first pivoting motor 460 drives the first pivoting shaft 461 to rotate, thereby pivoting the first arm 462, whereby the cleaning nozzle 450 moves to over the substrate W held by the spin chuck 421.

A tip of a cleaning supply pipe 463 is connected in communication with the cleaning nozzle 450. The cleaning supply pipe 463 is connected in communication with a cleaning liquid supply source R1 and a surface preparation liquid supply source R2 through a valve Va and a valve Vb, respectively. Controlling the opening and closing of the valves Va and Vb allows the selection of a processing liquid to be supplied to the cleaning supply pipe 463 and the adjustment of the amount of supply thereof. Specifically, a cleaning liquid is supplied to the cleaning supply pipe 463 by opening the valve Va, and a surface preparation liquid is supplied to the cleaning supply pipe 463 by opening the valve Vb.

The cleaning liquid supplied from the cleaning liquid supply source R1 or the surface preparation liquid supplied from the surface preparation liquid supply source R2 is fed through the cleaning supply pipe 463 to the cleaning nozzle 450. This provides the cleaning liquid or the surface preparation liquid from the cleaning nozzle 450 to the surface of the substrate W. Examples of the cleaning liquid used herein include deionized water, a solution of a complex (ionized) in deionized water, and the like. Examples of the surface preparation liquid used herein include hydrofluoric acid, and the like. The cleaning nozzle 450 used in this preferred embodiment is what is called a straight nozzle for directly ejecting the processing liquid fed thereto. In this preferred embodiment, deionized water is used as the cleaning liquid, and hydrofluoric acid is used as the surface preparation liquid. In the cleaning part 40, strict atmosphere control is exercised so as to prevent the atmosphere of the surface preparation liquid from leaking out within the apparatus.

A second pivoting motor 470 is provided on a different side of the spin chuck 421 than the above-mentioned side. A second pivoting shaft 471 is connected to the second pivoting motor 470. A second arm 472 is coupled to the second pivoting shaft 471 so as to extend in a horizontal direction, and a drying nozzle 451 is provided on a distal end of the second arm 472. The second pivoting motor 470 drives the second pivoting shaft 471 to rotate, thereby pivoting the second arm 472, whereby the drying nozzle 451 moves to over the substrate W held by the spin chuck 421.

A tip of a drying supply pipe 473 is connected in communication with the drying nozzle 451. The drying supply pipe 473 is connected in communication with an inert gas supply source R3 through a valve Vc. Controlling the opening and closing of the valve Vc allows the adjustment of the amount of inert gas to be supplied to the drying supply pipe 473.

The inert gas supplied from the inert gas supply source R3 is fed through the drying supply pipe 473 to the drying nozzle 451. This provides the inert gas from the drying nozzle 451 to the surface of the substrate W. Examples of the inert gas used herein include nitrogen gas (N2) and argon gas (Ar).

When supplying the cleaning liquid or the surface preparation liquid to the surface of the substrate W, the cleaning nozzle 450 is positioned over the substrate W held by the spin chuck 421 whereas the drying nozzle 451 is retracted to a predetermined position. When supplying the inert gas to the surface of the substrate W, on the other hand, the drying nozzle 451 is positioned over the substrate W held by the spin chuck 421 whereas the cleaning nozzle 450 is retracted to a predetermined position, as shown in FIG. 4.

The substrate W held by the spin chuck 421 is surrounded by a processing cup 423. A cylindrical partition wall 433 is provided inside the processing cup 423. A drainage space 431 for draining the processing liquid (the cleaning liquid or the surface preparation liquid) used for the processing of the substrate W is formed inside the partition wall 433 so as to surround the spin chuck 421. A collected liquid space 432 for collecting the processing liquid used for the processing of the substrate W is formed between the outer wall of the processing cup 423 and the partition wall 433 so as to surround the drainage space 431.

A drainage pipe 434 for guiding the processing liquid to a drainage processing apparatus (not shown) is connected to the drainage space 431, and a collection pipe 435 for guiding the processing liquid to a collection processing apparatus (not shown) is connected to the collected liquid space 432.

A splash guard 424 for preventing the processing liquid from the substrate W from splashing outwardly is provided over the processing cup 423. The splash guard 424 has a configuration rotationally symmetric with respect to the rotary shaft 425. A drainage guide groove 441 of a dog-legged sectional configuration is formed annularly in the inner surface of an upper end portion of the splash guard 424. A collected liquid guide portion 442 defined by an outwardly downwardly inclined surface is formed in the inner surface of a lower end portion of the splash guard 424. A partition wall receiving groove 443 for receiving the partition wall 433 in the processing cup 423 is formed near the upper end of the collected liquid guide portion 442.

The splash guard 424 is driven to move upwardly and downwardly in a vertical direction by a guard driving mechanism (not shown) including a ball screw mechanism and the like. The guard driving mechanism moves the splash guard 424 upwardly and downwardly between a collection position in which the collected liquid guide portion 442 surrounds the edge portion of the substrate W held by the spin chuck 421 and a drainage position in which the drainage guide groove 441 surrounds the edge portion of the substrate W held by the spin chuck 421. When the splash guard 424 is in the collection position (the position shown in FIG. 4), the processing liquid splashed from the edge portion of the substrate W is guided by the collected liquid guide portion 442 into the collected liquid space 432, and is then collected through the collection pipe 435. When the splash guard 424 is in the drainage position, on the other hand, the processing liquid splashed from the edge portion of the substrate W is guided by the drainage guide groove 441 into the drainage space 431, and is then drained through the drainage pipe 434. In this manner, the drainage and collection of the processing liquid can be selectively carried out.

Referring again to FIG. 3, the stand-by unit 55 disposed in the upper tier of the cleaning part 40 includes a table 56, and a plurality of (e.g., three) support pins 57 provided on the upper surface of the table 56. The support pins 57 are capable of holding the substrate W stationary in a horizontal position. The table 56 may be rotatable, and the stand-by unit 55 may have a pre-alignment function for previously adjusting the orientation of the substrate W.

As shown in FIG. 1, a first transport robot 61 and a second transport robot 62 which serve as the transport mechanism 60 are provided within the exposure chamber 11. The first transport robot 61 includes a bendable arm portion 61b, and a guide portion 61a for guiding the arm portion 61b. The arm portion 61b moves along the guide portion 61a. Similarly, the second transport robot 62 includes a bendable arm portion 62b, and a guide portion 62a for guiding the arm portion 62b. The arm portion 62b moves along the guide portion 62a.

A carrying-in table 81 and a carrying-out table 82 are provided near a side portion of the exposure chamber 11 in contact with the interface 5. The substrate processing apparatus 1 and the coater-and-developer 2 are connected to each other so that the transport robot 5a of the interface 5 is able to transfer and receive a substrate W to the carrying-in table 81 and from the carrying-out table 82. The carrying-in table 81 is used for the transfer of an unexposed substrate W, and the carrying-out table 82 is used for the transfer of an exposed substrate W.

A housing part 90 for housing a dummy substrate DW is provided within the exposure chamber 11. The dummy substrate DW is used in the exposure part 20 compatible with the immersion exposure process to prevent deionized water from entering the inside of the substrate stage 27 during an alignment process for adjusting the exposure position of the pattern image, such as stage position calibration and the like. The dummy substrate DW is approximately identical in shape and size with a normal substrate W (for semiconductor device fabrication). The material of the dummy substrate DW may be the same as that of the normal substrate W (for example, silicon), but is required only to prevent contaminants from dissolving out in a liquid during the immersion exposure process. The dummy substrate DW may have a surface made water-repellent. An example of the technique of making the surface of the dummy substrate DW water-repellent is a coating process using a water-repellent material such as a fluorine compound, a silicon compound, acrylic resin, polyethylene and the like. Alternatively, the dummy substrate DW itself may be made of the above-mentioned water-repellent materials. When the alignment process is not performed, e.g. when the normal exposure process is performed, the dummy substrate DW is unnecessary and therefore is held in the housing part 90. The housing part 90 may have a multi-tier cabinet structure capable of storing a plurality of dummy substrates DW.

The first transport robot 61 of the transport mechanism 60 transports a substrate W between the exposure part 20 and the cleaning part 40. When the first transport robot 61 transfers and receives the substrate W to and from the exposure part 20, the substrate stage 27 is moved to a substrate changing position within the exposure part 20 (FIG. 1). Then, the arm portion 61b makes upward and downward movements and bending and stretching movements to thereby transfer and receive the substrate W to and from the substrate stage 27. When the exposure part 20 performs the exposure process on the substrate W, the substrate stage 27 is moved to an exposure processing position lying under the projection optical system 24 (FIG. 2).

The second transport robot 62, on the other hand, transports a substrate W between the carrying-in table 81 and carrying-out table 82, and the cleaning part 40. The arm portion 62b of the second transport robot 62 makes upward and downward movements and bending and stretching movements to thereby receive a resist-coated substrate W from the carrying-in table 81 and transfer an exposed substrate W to the carrying-out table 82.

Both the first transport robot 61 and the second transport robot 62 are able to transfer and receive a substrate W to and from the two units of the cleaning part 40, i.e. the cleaning unit 41 and the stand-by unit 55. Specifically, a first side wall surface of the cleaning unit 41 opposed to the first transport robot 61 and a second side wall surface of the cleaning unit 41 opposed to the second transport robot 62 are formed with respective openings which allow the arm portion 61b and the arm portion 62b to gain access to the cleaning unit 41 therethrough. Similarly, a first side wall surface of the stand-by unit 55 opposed to the first transport robot 61 and a second side wall surface of the stand-by unit 55 opposed to the second transport robot 62 are formed with respective openings which allow the arm portion 61b and the arm portion 62b to gain access to the stand-by unit 55 therethrough. Thus, the first transport robot 61 and the second transport robot 62 are able to transfer and receive a substrate W to and from each other by way of the cleaning unit 41 or the stand-by unit 55.

In this preferred embodiment, the first transport robot 61 transports the dummy substrate DW into and out of the housing part 90. The first transport robot 61 is able to transport the dummy substrate DW taken out of the housing part 90 to both the exposure part 20 and the cleaning part 40.

The substrate processing apparatus 1 further includes a controller CT for controlling the operation of the entire substrate processing apparatus 1. The controller CT is similar in hardware construction to a typical computer. Specifically, the controller CT includes a CPU for performing various computation processes, a ROM or read-only memory for storing a basic program therein, a RAM or readable/writable memory for storing various pieces of information therein, a magnetic disk for storing control applications and data therein, and the like. By executing predetermined application software, the controller CT controls and causes the processing mechanisms such as the exposure part 20, the cleaning part 40, the transport mechanism 60 and the like to perform various processes.

The coater-and-developer 2, on the other hand, is provided with a separate control mechanism independent of the controller CT of the substrate processing apparatus 1. In other words, the coater-and-developer 2 does not operate under the control of the controller CT of the substrate processing apparatus 1, but controls its own operation alone. The host computer 3 ranks as a higher level control mechanism than the controller CT provided in the substrate processing apparatus 1 and than the control mechanism of the coater-and-developer 2. The host computer 3 is also similar in hardware construction to a typical computer. Typically, a plurality of substrate processing apparatuses 1 and a plurality of coater-and-developers 2 according to this preferred embodiment are connected to the host computer 3. The host computer 3 provides a recipe containing descriptions about a processing procedure and processing conditions to each of the substrate processing apparatuses 1 and the coater-and-developers 2 connected thereto. The recipe provided from the host computer 3 is stored in a storage part (e.g., a memory) of the controller CT of each of the substrate processing apparatuses 1.

Next, the operation of the substrate processing apparatus 1 according to this preferred embodiment will be described. First, brief description will be given on a procedure for the processing of a normal substrate W in the substrate processing apparatus 1. The controller CT controls the mechanical parts including the exposure part 20, the cleaning part 40, the transport mechanism 60 and the like of the substrate processing apparatus 1, whereby the processing procedure to be described below is performed.

First, the transport robot 5a places a substrate W coated with a photoresist which is a photosensitive material in the coater-and-developer 2 onto the carrying-in table 81. In this preferred embodiment, a chemically amplified resist is used as the photoresist. The second transport robot 62 transports the substrate W placed on the carrying-in table 81 to the cleaning part 40 and into the stand-by unit 55. A pre-alignment process may be performed on the substrate W, as required, in the stand-by unit 55.

Next, the first transport robot 61 transports the substrate W out of the stand-by unit 55 to the exposure part 20. The substrate stage 27 is previously moved to the substrate changing position in the exposure part 20, and the first transport robot 61 transfers the substrate W to the substrate stage 27. Thereafter, the substrate stage 27 with the resist-coated substrate W placed thereon moves to the exposure processing position lying under the projection optical system 24, and the exposure process starts. The exposure part 20 performs the step-and-repeat exposure in such a manner as to project the image of the pattern formed in the mask 23 sequentially in batches of several chips onto the substrate W to print the pattern thereon. Because the substrate W is coated with the chemically amplified resist in this preferred embodiment, an acid is formed by a photochemical reaction in an exposed portion of the resist film formed on the substrate W.

The exposure part 20 performs the immersion exposure process for projecting the pattern image of the mask 23 onto the substrate W while the liquid supply mechanism 25 and the liquid collecting mechanism 26 fill the gap between the substrate W and the projection optical system 24 with the liquid. This achieves a high resolution with virtually no change of the conventional light source and exposure process.

After the completion of the exposure process in the exposure part 20, the substrate stage 27 moves again to the substrate changing position, and the first transport robot 61 receives the exposed substrate W. The first transport robot 61 transports the substrate W to the cleaning part 40 and into the cleaning unit 41. When the substrate W is transported into the cleaning unit 41, the splash guard 424 is moved downwardly in the cleaning unit 41, and the first transport robot 61 places the substrate W onto the spin chuck 421. The substrate W placed on the spin chuck 421 is held in a horizontal position under suction by the spin chuck 421.

Next, the splash guard 424 moves to the above-mentioned drainage position, and the cleaning nozzle 450 moves to over the center of the substrate W. Thereafter, the rotary shaft 425 starts rotating. As the rotary shaft 425 rotates, the substrate W held by the spin chuck 421 is rotated. Thereafter, the valve Va is opened to apply the cleaning liquid from the cleaning nozzle 450 onto the upper surface of the substrate W. In this case, deionized water is applied as the cleaning liquid to the substrate W. Thus, the process of cleaning the substrate W proceeds, and the liquid for immersion (in this case, deionized water), if any, remaining on the substrate W after the immersion exposure process is flushed away with the cleaning liquid. The liquid splashed from the rotating substrate W by centrifugal force is guided by the drainage guide groove 441 into the drainage space 431, and is drained through the drainage pipe 434.

After a lapse of a predetermined time period, the speed of rotation of the rotary shaft 425 decreases. This decreases the amount of deionized water spattered by the rotation of the substrate W to form a film of deionized water on the entire surface of the substrate W in such a manner that a puddle of deionized water remains on the substrate W. Alternatively, a film of deionized water may be formed on the entire surface of the substrate W by stopping the rotation of the rotary shaft 425.

Next, the supply of the deionized water serving as the cleaning liquid is stopped. The cleaning nozzle 450 is retracted to a predetermined position, and the drying nozzle 451 moves to over the center of the substrate W. Thereafter, the valve Vc is opened to apply an inert gas from the drying nozzle 451 to near the center of the upper surface of the substrate W. In this preferred embodiment, nitrogen gas is applied as the inert gas. Thus, the water or moisture in the center of the substrate W is forced toward the peripheral edge portion of the substrate W. As a result, the film of deionized water remains only in the peripheral edge portion of the substrate W.

Next, the speed of rotation of the rotary shaft 425 increases again, and the drying nozzle 451 gradually moves from over the center of the substrate W toward over the peripheral edge portion of the substrate W. Thus, a great centrifugal force is exerted on the film of deionized water remaining on the substrate W, and the inert gas impinges on the entire surface of the substrate W, whereby the film of deionized water on the substrate W is reliably removed. As a result, the substrate W is dried with reliability.

Next, the supply of the inert gas is stopped. The drying nozzle 451 is retracted to a predetermined position, and the rotation of the rotary shaft 425 is stopped. Thereafter, the splash guard 424 is moved downwardly, and the second transport robot 62 transports the substrate W out of the cleaning unit 41. This completes the cleaning process and the subsequent drying process in the cleaning unit 41. The position of the splash guard 424 during the cleaning and drying processes is preferably appropriately changed depending on the need for the collection and drainage of the processing liquid.

The second transport robot 62 transports the substrate W subjected to the cleaning and drying processes in the cleaning unit 41, and places the substrate W onto the carrying-out table 82. The exposed substrate W placed on the carrying-out table 82 is returned into the coater-and-developer 2 by the transport robot 5a, and is subjected to a post-exposure bake process and the development process in the coater-and-developer 2.

In this way, if the liquid used during the immersion exposure process remains on the substrate W after the exposure process, the substrate W is cleaned and dried in the cleaning unit 41 immediately after the exposure process. This prevents the above-mentioned remaining liquid from contaminating at least the mechanical parts such as the second transport robot 62, the carrying-out table 82 and the transport robot 5a of the coater-and-developer 2.

Because the cleaning part 40 as well as the exposure part 20 is provided within the exposure chamber 11, the exposed substrate W after the completion of the immersion exposure process is rapidly transported from the exposure part 20 to the cleaning unit 41 and subjected to the cleaning process. This minimizes contamination resulting from the liquid adhering to the substrate W.

Additionally, the process of cleaning the substrate W immediately after the immersion exposure process under the control of only the controller CT of the substrate processing apparatus 1 facilitates the overall control, as compared with the process of cleaning the exposed substrate W after returning the substrate W into the coater-and-developer 2.

In the exposure part 20, the alignment process is performed, as appropriately, which is the process of calibrating the position of the substrate stage 27 and the position of the mask 23 to adjust the exposure position of the patter image. The exposure part 20 which performs the immersion exposure process uses the dummy substrate DW to prevent deionized water from entering the inside of the substrate stage 27 during the alignment process. Specifically, the dummy substrate DW is fitted in the recessed portion surrounded by the auxiliary plate 27a of the substrate stage 27 when the alignment process is performed. This prevents the liquid from entering the inside of the substrate stage 27, but creates a likelihood that the liquid adheres to the dummy substrate DW to remain in the form of droplets on the dummy substrate DW. When left unremoved, such droplets dry to become a source of contamination or impair the water repellency of the dummy substrate DW.

This preferred embodiment avoids such problems by cleaning the dummy substrate DW also in the cleaning unit 41. The procedure for the process of cleaning the dummy substrate DW is substantially similar to the above-mentioned procedure for the process of cleaning the normal substrate W. There is another similarity in that the controller CT controls the mechanical parts such as the exposure part 20, the cleaning part 40, the transport mechanism 60 and the like of the substrate processing apparatus 1 to perform the cleaning process on the dummy substrate DW. Specifically, when the exposure part 20 performs the alignment process, the first transport robot 61 transports the dummy substrate DW from the housing part 90 to the exposure part 20. After the exposure part 20 performs the alignment process using the liquid for immersion, the first transport robot 61 takes the dummy substrate DW from the substrate stage 27 and transports the dummy substrate DW into the cleaning unit 41 of the cleaning part 40. The process of cleaning the dummy substrate DW in the cleaning unit 41 is exactly identical with the above-mentioned process of cleaning the normal substrate W. After the dummy substrate DW is subjected to the cleaning process and the drying process, the first transport robot 61 receives the cleaned dummy substrate DW from the cleaning unit 41 to house the dummy substrate DW into the housing part 90 again.

In this way, if the liquid adheres to the dummy substrate DW in the alignment process in the exposure part 20, the dummy substrate DW is transported to the cleaning unit 41 and cleaned in the cleaning unit 41. This prevents the dummy substrate DW from being contaminated. The clean dummy substrate DW subjected to the cleaning process is used for the execution of the alignment process. This reduces the contamination of the mechanisms such as the first transport robot 61, the substrate stage 27 of the exposure part 20, and the like.

When the dummy substrate DW is water-repellent, there are cases where the water repellency of the dummy substrate DW is impaired due to contamination. However, the removal of the contaminants by the above-mentioned cleaning process restores the water repellency of the substrate surface. As a result, the dummy substrate DW is able to hold the immersion liquid with reliability also during the alignment process. This also significantly reduces the costs, as compared with the process of replacing dummy substrates DW made less water-repellent one by one.

Because the cleaning part 40 as well as the exposure part 20 is provided within the exposure chamber 11, the dummy substrate DW after the completion of the alignment process is rapidly transported from the exposure part 20 to the cleaning unit 41 and subjected to the cleaning process. Thus, the cleaning process is performed on the dummy substrate DW before the liquid adhering to the dummy substrate DW in the alignment process dries. This minimizes the contamination of the dummy substrate DW.

Additionally, the process of cleaning the dummy substrate DW immediately after the alignment process under the control of only the controller CT of the substrate processing apparatus 1 facilitates the overall control, as compared with the process of cleaning the dummy substrate DW subjected to the alignment process after returning the dummy substrate DW into the coater-and-developer 2.

While the preferred embodiment according to the present invention is described hereinabove, various changes and modifications in addition to those described above may be made therein without departing from the spirit of the invention. For example, although the substrate W is cleaned immediately after the exposure process in the above-mentioned preferred embodiment, the substrate W may be cleaned immediately before the exposure process in the exposure part 20 in place of or in addition to the cleaning of the substrate W immediately after the exposure process. Specifically, the second transport robot 62 for transporting the resist-coated substrate W transports the substrate W into the cleaning unit 41, rather than the stand-by unit 55, of the cleaning part 40 under the control of the controller CT. The first transport robot 61 transports the substrate W subjected to the cleaning process in the cleaning unit 41 to the exposure part 20. This reduces the contamination of the mechanisms within the exposure part 20 to reduce the occurrence of defects because the substrate W immediately after being cleaned in the cleaning unit 41 is transported into the exposure part 20.

Although the dummy substrate DW is cleaned immediately after the alignment process in the above-mentioned preferred embodiment, the dummy substrate DW may be cleaned immediately before the alignment process in the exposure part 20 in place of or in addition to the cleaning of the dummy substrate DW immediately after the alignment process. Specifically, the first transport robot 61 transports the dummy substrate DW from the housing part 90 to the cleaning part 40 and into the cleaning unit 41 under the control of the controller CT. The first transport robot 61 transports the dummy substrate DW subjected to the cleaning process in the cleaning unit 41 to the exposure part 20, and the alignment process is performed in the exposure part 20. This reduces the contamination of the mechanisms within the exposure part 20 to improve the accuracy of the alignment process in the exposure part 20 because the clean dummy substrate DW immediately after being cleaned in the cleaning unit 41 is transported into the exposure part 20 and used in the alignment process.

The substrate processing apparatus 1 may be scheduled to perform the cleaning process on the dummy substrate DW periodically at predetermined time intervals. Specifically, a module for the periodic cleaning of the dummy substrate DW at preset time intervals is included in application software to be executed by the controller CT, and the controller CT which executes the application software causes the first transport robot 61 and the cleaning part 40 to periodically perform the cleaning process on the dummy substrate DW. The periodic cleaning of the dummy substrate DW keeps the surface condition of the dummy substrate DW always the same with stability to consequently improve the accuracy of the alignment process in the exposure part 20. The time to periodically perform the cleaning process on the dummy substrate DW may be, for example, the time of regular maintenance of the substrate processing apparatus 1. The execution of the cleaning process on the dummy substrate DW as one of the maintenance processes at the time of regular maintenance eliminates the apprehension of interference with the exposure process of normal substrates W, to thereby facilitate the control of the cleaning and transport. However, the execution of the cleaning process on the dummy substrate DW immediately before the alignment process allows the execution the alignment process using the cleaner dummy substrate DW obtained immediately after the cleaning. The execution of the cleaning process on the dummy substrate DW immediately after the alignment process ensures the removal of a source of contamination before the adhering liquid dries. The time intervals at which the dummy substrate DW is cleaned periodically may be inputted from the outside to the controller CT. Alternatively, the host computer 3 gives an instruction to the controller CT to cause the execution of the periodic cleaning.

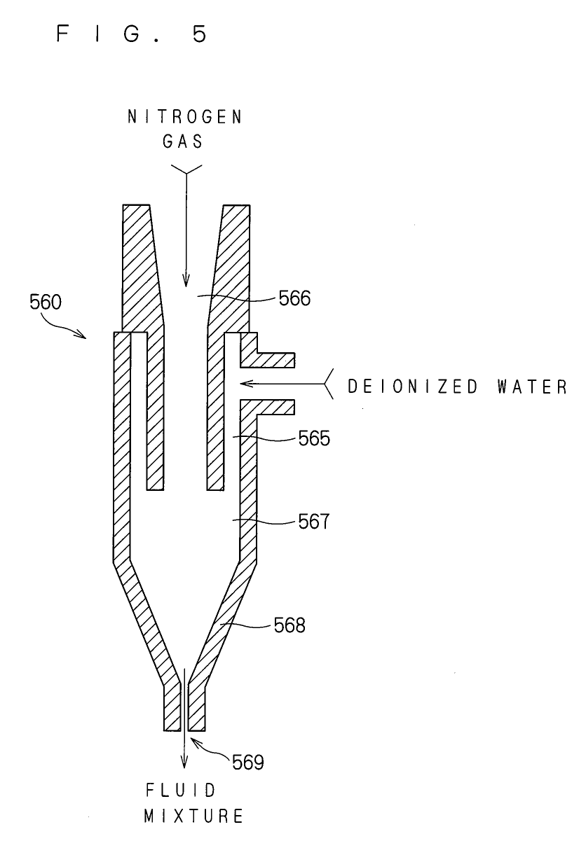

Although the straight nozzle is used as the cleaning nozzle 450 in the above-mentioned preferred embodiment, a two-fluid nozzle which mixes the cleaning liquid such as deionized water and a gas such as nitrogen gas together to form and eject droplets of the cleaning fluid in the form of a mist may be used as the cleaning nozzle 450 in place of the straight nozzle. FIG. 5 is a schematic sectional view showing an example of the structure of the two-fluid nozzle. The two-fluid nozzle 560 is what is called an internal mix two-fluid nozzle which mixes nitrogen gas supplied from a nitrogen gas supply source (not shown) and deionized water supplied from a deionized water supply source (not shown) together within the nozzle to form and eject droplets of deionized water in the form of a mist toward the substrate W. As shown in FIG. 5, the two-fluid nozzle 560 has a double-tube structure such that a gas inlet tube 566 through which the nitrogen gas is supplied is inserted in a cleaning liquid inlet tube 565 through which the deionized water is supplied. A mixing part 567 for mixing the nitrogen gas and the deionized water together is provided downstream from the end of the gas inlet tube 566 inside the cleaning liquid inlet tube 565.

Pressurized nitrogen gas and deionized water are mixed in the mixing part 567 to form a fluid mixture including droplets of deionized water in the form of a mist. The formed fluid mixture is accelerated by an acceleration tube 568 downstream from the mixing part 567, and is ejected from an outlet port 569. The two-fluid nozzle 560 may be what is called an external mix two-fluid nozzle which mixes nitrogen gas and deionized water together by causing a collision therebetween in an open space outside the nozzle to form and eject droplets of deionized water in the form of a mist toward the substrate W.

The cleaning nozzle 450 used herein may be an ultrasonic cleaning nozzle for ejecting a cleaning liquid subjected to ultrasound, and a high-pressure cleaning nozzle for ejecting a cleaning liquid at high pressure, as well as that described above. A cleaning brush for performing the cleaning process in contact with or in proximity to the substrate W may be provided in place of or in addition to the cleaning nozzle 450. The ultrasonic cleaning nozzle, the high-pressure cleaning nozzle and the cleaning brush used herein may be those known in the art.

The surface preparation may be done by supplying a chemical solution to the dummy substrate DW in place of performing the cleaning process on the dummy substrate DW in the cleaning unit 41 or after performing the cleaning process. An example of the chemical solution to be supplied in the cleaning unit 41 includes hydrofluoric acid. When the dummy substrate DW is a silicon wafer as well as the normal substrate W, a silicon oxide film (a native oxide film) is formed on the surface of the dummy substrate DW to make the surface hydrophilic, thereby impairing the water repellency of the dummy substrate DW with time. The supply of hydrofluoric acid serving as the chemical solution to the surface of the dummy substrate DW removes the silicon oxide film to expose a silicon body, thereby making the surface of the dummy substrate DW water-repellent. That is, the supply of the chemical solution imparts (or restores) the water repellency to the surface of the dummy substrate DW. Specifically, while the dummy substrate DW held by the spin chuck 421 is rotated, the valve Vb is opened to feed hydrofluoric acid from the surface preparation liquid supply source R2 through the cleaning nozzle 450 onto the upper surface of the dummy substrate DW. The chemical solution supplied to the dummy substrate DW is not limited to hydrofluoric acid. Depending on the materials of the dummy substrate DW, such a material as a fluorine compound, acrylic resin and the like, for example, may be supplied to the dummy substrate DW to perform a coating process for making the surface of the dummy substrate DW water-repellent in the cleaning unit 41. When the chemical solution such as hydrofluoric acid is supplied in the cleaning unit 41, strict atmosphere control is required so as to prevent the atmosphere from leaking out of the cleaning unit 41.

The cleaning unit 41 for cleaning the normal substrate W is also used to perform the cleaning process on the dummy substrate DW in the above-mentioned preferred embodiment. However, individual cleaning processing units designed specifically for the normal and dummy substrates W and DW may be provided. In particular, the substrate W coated with a chemically amplified resist, immediately after the exposure, is highly susceptible to an alkaline atmosphere. Thus, it is preferable to provide a cleaning processing unit designed specifically for the dummy substrate DW when the process of supplying a chemical solution to the dummy substrate DW is performed in the cleaning processing unit.

Aside from the dummy substrate DW, a cleaning substrate for cleaning use only may be prepared in the substrate processing apparatus 1 to clean the substrate stage 27, and be cleaned in the cleaning unit 41. The cleaning substrate is similar to the dummy substrate DW, and is housed in the housing part 90 separately from the dummy substrate DW. Like the dummy substrate DW, the cleaning substrate is transported to the cleaning unit 41 at an appropriate time and is cleaned therein. The procedure for the process of cleaning the cleaning substrate is substantially identical with that for the process of cleaning the normal substrate W described above. During the process of cleaning the substrate stage 27, deionized water is supplied in a manner similar to that used during the alignment process while the clean cleaning substrate is used, whereby contaminants such as particles adhering to the substrate stage 27 (in particular, near the auxiliary plate 27a) are adsorbed on the cleaning substrate and are collected. This easily removes the contamination of the substrate stage 27 by cleaning without stopping the operation of the substrate processing apparatus 1. The cleaning substrate which has adsorbed the contaminants after the cleaning process is cleaned again in the cleaning unit 41.

The substrate to be processed in the substrate processing apparatus 1 according to the present invention is not limited to a semiconductor wafer, but may be a glass substrate for a liquid crystal display device and the like.

While the invention has been described in detail, the foregoing description is in all aspects illustrative and not restrictive. It is understood that numerous other modifications and variations can be devised without departing from the scope of the invention.

What is claimed is:

1. A substrate processing apparatus for performing an exposure process by printing a pattern on a substrate coated with a photosensitive material, said substrate processing apparatus comprising:
an exposure part for projecting a pattern image on a substrate;
an exposure chamber for housing said exposure part;
a cleaning part provided within said exposure chamber for performing a cleaning process on the substrate; and
a transport element for transporting the substrate between said exposure part and said cleaning part.

2. The substrate processing apparatus according to claim 1, further comprising
a housing part provided within said exposure chamber for housing a dummy substrate, the dummy substrate being used when said exposure part adjusts the exposure position of the pattern image,
wherein said transport element transports the substrate or the dummy substrate between said exposure part, said cleaning part and said housing part, and
wherein said cleaning part cleans the dummy substrate.

3. The substrate processing apparatus according to claim 1, further comprising
a cleaning controller for controlling said cleaning part and said transport element to clean the substrate immediately before or immediately after said exposure part performs the exposure process.

4. The substrate processing apparatus according to claim 2, further comprising
a cleaning controller for controlling said cleaning part and said transport element to clean the dummy substrate immediately before or immediately after said exposure part adjusts the exposure position of the pattern image.

5. The substrate processing apparatus according to claim 2, further comprising
a cleaning controller for controlling said cleaning part and said transport element to periodically clean the dummy substrate.

6. The substrate processing apparatus according to claim 1, wherein
said cleaning part includes a drying mechanism for performing a drying process on the substrate after the cleaning process is performed on the substrate.

7. The substrate processing apparatus according to claim 1, wherein
said exposure part includes
a projection optical system for projecting the pattern image on the substrate to expose the substrate;
a liquid supply mechanism for supplying a liquid to a gap between said projection optical system and the substrate;
a liquid collecting mechanism for collecting the liquid with which said liquid supply mechanism fills the gap between the projection optical system and the substrate, and
an illumination optical system for emitting light for exposure toward said projection optical system, with the gap between said projection optical system and the substrate filled with the liquid by said liquid supply mechanism and said liquid collecting mechanism.
